(19) United States
(12) Patent Application Publication
(10) Pub. No.: US 2005/0187989 A1
(43) Pub. Date: Aug. 25, 2005

(54) Version management system, version management server device, and storage device control unit

(75) Inventor: Seiji Kaneko, Zama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/857,772

(22) Filed: May 28, 2004

(30) Foreign Application Priority Data
Feb. 19, 2004 (JP) 2004-042708

(51) Int. Cl. G06F 7/00

(52) U.S. Cl. 707/203

(57) ABSTRACT

A version management system that includes: a CPU; memory; communications interface section connected to an information processor over a communications network for communications therewith; a repository database for storing a file including version information; a check-out processing section for checking out the file from the repository database in response to the check-out request received from the information processor; a data writing request receiving section for receiving from the information processor a data writing request including information for identifying the file; a file writing processing section for performing data writing to the checked out file in response to the data writing request; a check-in processing section for checking in the file to the repository database in response to the check-in request received from the information processor; and a backup processing section for performing backup of the file stored in the repository database responding to completion of check-in by the check-in processing section.

### CROSS-REFERENCES TO RELATED APPLICATIONS

This application relates to and claims priority from Japanese Patent Application No. 2004-042708, filed on Feb. 19, 2004, the entire disclosure of which is incorporated herein by reference.

### BACKGROUND OF THE INVENTION

The present invention relates to a version management system a version management server device, and a storage device control unit.

1. Field of the Invention

In recent years, the data amount processed by information processing systems has been showing a rapid increase, and to deal with such an increase, disk array apparatuses have been popular as storage devices for data storage and management. A disk array apparatus includes a plurality of hard disk drives, thereby providing an information processor with a storage resource of a larger capacity. For such a disk array apparatus, feature enhancement has been successfully applied, and any mission-critical disk array apparatus is provided with, as standard equipment, a capability of data copying with other disk array apparatuses (remote replication), a capability of data copy storage (in the below, referred to as data copying capability), and others. For details of such a data copying capability, refer to JP-A-2000-276306.

Further, recently developed feature for disk array apparatus is a NAS (Network Attached Storage) technology for providing information processors with file systems over a network following a TCP/IP (Transmission Control Protocol/Internet Protocol) protocol through connection between the information processors and disk array apparatuses. With such file systems, a snapshot function has been in practical use for storing the file contents at some time point. In further advanced file systems, a version control function is equipped for managing a history record of file changes. As a NAS equipped with such a version control mechanism, WebDAV (Web Distributed Authoring and Versioning) has been receiving attention.
[Patent Document 1] JP-A-2000-276306

2. Description of the Related Art

With NAS systems equipped with a version control function exemplified by WebDAV, previous files are restorable by storing operational histories of files as log into a database referred to as repository. Also for disk array apparatuses, a similar mechanism is now available by making copies of data in a storage region for storage into another storage region. With this mechanism, the original data becomes restorable from the storage region having stored the data copies.

The issue here is that no cooperation is observed between file version control mechanism provided by WebDAV and data copying feature provided, by disk array apparatuses, and thus file version control and data copying have required each separate control. For betterment, the disk array apparatuses are expected to have better file integrity through combination with the version control mechanism by WebDAV, for example.

### SUMMARY OF THE INVENTION

The present invention is proposed in consideration of such circumstances, and an object thereof is to provide, through combination with a version control mechanism, a version management system, a version management server device, and a storage device control unit.

To achieve the above object, a main aspect of the present invention is directed to a version management system that includes: at least one CPU; memory; a communications interface section connected to at least one information processor over a communications network for communications therewith; at least one repository database for storing a file including version information; at least one check-out processing section for receiving a check-out request that is a command coming from the information processor for instructing to check-out the file from the repository database, and in response to the received check-out request, for checking out the file from the repository database; a data writing request receiving section for receiving from the information processor a data writing request including information for identifying the file; at least one file writing processing section for performing data writing to the checked out file in response to the data writing request; at least one check-in processing section for receiving a check-in request that is a command coming from the information processor for instructing to check-in the checked out file to the repository database, and in response to the received check-in request, for checking in the checked out file to the repository database; and at least one backup processing section for performing backup of the file stored in the repository database in response to completion of check-in by the check-in processing section. In the system, the check-out processing section, the data writing request writing section, the file writing processing section, the check-in processing section, and the backup processing section are all realized by the CPU executing a program stored in the memory.

According to the present invention, through combination with a version control mechanism, a version management system, aversion management server device, and a storage device control unit are successfully provided.

### BRIEF DESCRIPTION OF THE DRAWINGS

FIG. 1 is a diagram showing the entire structure of an information processing system 1 of a first embodiment of the present invention;

FIG. 2 is a function block diagram showing capabilities provided by a version management system 20 of the first embodiment;

FIG. 3 is a diagram showing the flow of a file update process of the first embodiment;

FIG. 4 is a diagram showing the flow of the file update process of the first embodiment;

FIG. 5 is a diagram showing the entire structure of the information processing system 1 of a second embodiment of the present invention in which the version management system 20 is structured by a version management server device 100 and a disk array apparatus 200;

FIG. 6 is a diagram showing the structure of a channel control section 210 of the second embodiment;

FIG. 7 is a diagram showing the structure of the information processing system 1 of a third embodiment of the present invention including the disk array apparatus 200 and another disk array apparatus 400;

FIG. 8 is a diagram showing the structure of the information processor 1 of a fourth embodiment of the present invention in which an information processor 10 and the disk array apparatus 200 are connected together;

FIG. 9 is a diagram showing the flow of a process for directly instructing the disk array apparatus 200 to perform backup from the information processor 10 of the fourth embodiment; and

FIG. 10 is a diagram showing the structure of the disk array apparatus 200 of a fifth embodiment of the present invention.

### DESCRIPTION OF THE PREFERRED EMBODIMENTS

### First Embodiment

===System Structure===

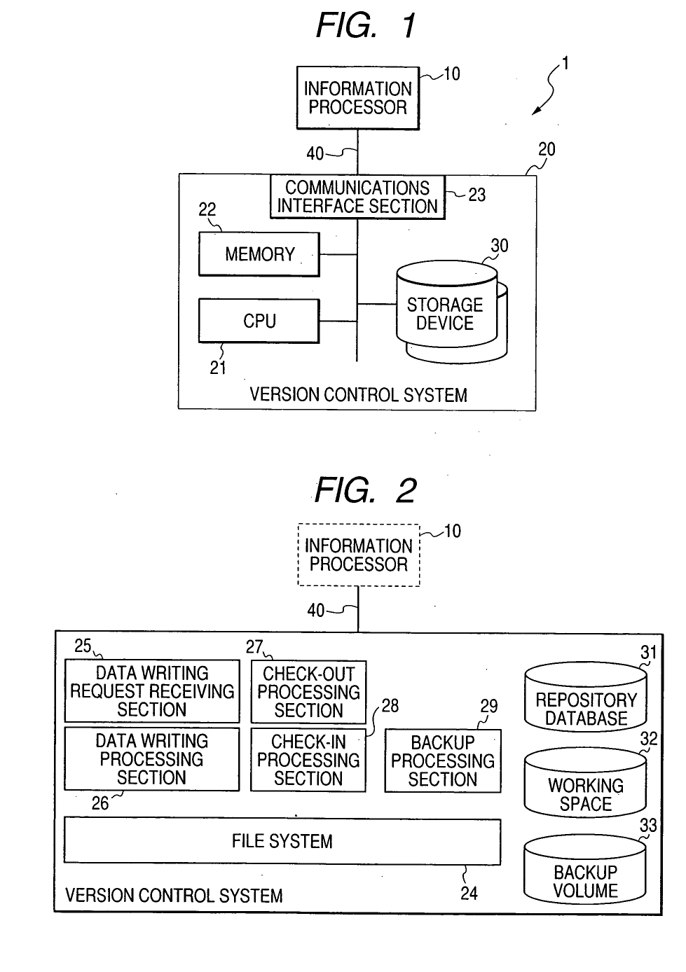

FIG. 1 shows the entire structure of an information processing system 1 of a first embodiment of the present invention. The information processing system 1 is structured by an information processor 10 and a version management system 20.

The information processor 10 is connected to the version management system 20 over a network 40 for communications therewith. The network 40 is exemplified by LAN (Local Area Network), the Internet, and others. The information processor 10 may be plurally included.

The information processor 10 is a computer including a CPU (Central Processing Unit), memory, and the like. The information processor 10 is exemplified by a personal computer, a workstation, a mainframe, and others. The information processor 10 makes an access to a file system provided by the version management system 20 by forwarding a data input/output request to the version management system 20. Here, the data input/output request includes information for file identification, and such a request is referred to as file access request below. The information for file identification included in the file access request is specifically a file name or some equivalent identifier.

Following a WebDAV protocol, the information processor 10 forwards a file access request to the version management system 20 over the network 40. The details of the WebDAV protocol are defined in RFC (Request for Comments) 2518, RFC 3253, and others.

The version management system 20 exercises version control over files, those under the control of a file system. The version management system 20 takes charge of information management, e.g., information indicating the type of file operation, and information indicating any change made by the file operation.

The version management system 20 is realized by one or more of a computer equipped with a CPU 21, memory 22, a communications interface section 23, and a storage device 30. By the CPU 21 executing a program stored in the memory 22, realized are a file system and a version control capability for file management by the file system. The communications interface section 23 carries out communications with the information processor 10 over the network 40. The communications interface section 23 is exemplified by an Ethernet™ adapter. The storage device 30 stores data, application programs, and others, and is exemplified by multiple hard disk drives, or a semiconductor storage devices. The storage device 30 may be structured separately from the computer of the above type. If this is the case, the storage device 30 may be connected, for communications, to the computer structuring the version management system 20 through an SCSI (Small Computer System Interface), or a Fibre Channel cable, for example.

===Structure of Version Management System===

FIG. 2 is a function diagram of the version management system 20.

A file system section 24 takes charge of establishing correspondences between names of files having been stored in the storage device 30, and addresses on the storage device 30 having stored data corresponding to the file names.

A data writing request receiving section 25 receives, from the information processor 10, a file access request asking for data writing into a file. In the below, such a request is referred to as data writing request.

In response to the data writing request received by the data writing request receiving section 25, a data writing processing section 26 performs data writing to a file. Specifically, the data writing processing section 26 forwards an SCSI or a Fibre Channel writing command to the storage device 30. With an designating address of the storage device 30 identified by the file system 24.

A repository database 31 is provided for storing file version information, and in the present embodiment, stores files each including its corresponding version information. Here, the version information includes date and time of file storage into the repository database 31, number and character assigned at the time of file addition to the repository database 31, names designated by a user using the files, and the like.

The repository database 31 includes the contents (data) of files corresponding to the respective versions. Instead of storing the file contents (data) in its entirety as such, reproducing the contents (data) of files corresponding to the respective versions is a possibility. In this case, used is data previously stored for indicating any difference between the versions. This can save the storage capacity used for file storage. The repository database 31 may include (store) information (meta information) indicating what file is stored under which name, information (operational histories) indicating file operations such as file reading and writing, file comment information, and the like.

A check-out processing section 27 receives, from the information processor 10, a command asking for check-out (CHECKOUT: referred below to as check-out request). Here, checking-out is making any file in the repository database 31 corresponding to specific version information available for the information processor 10 for data reading or writing. Making any file available for the information processor 10 for data reading or writing means file reading from the repository database 31 to a working space 32 that is a storage region provided by the storage device 30. Here, not to repeatedly check-out the same file, exercising exclusive control is an option. If this is the case, the repository database 31 may include (store) information about such exclusive control.

A check-in processing section 28 receives, from the information processor 10, a command asking for check-in defined by WebDAV (CHECKIN: referred below to as check-in request). Here, checking-in is registering file change histories and logging information into the repository database 31. Such file check-in into the repository database 31 allows search of a file change history, or retrieval of files of previous versions.

A backup processing section 29 performs backup of files stored in the repository database 31. This backup is done by storing copies of files stored in the repository database 31 into a backup volume 33 that is a storage region of the storage device 30. Alternatively, the backup volume 33 may be structured not to belong to the storage device 30. In this case, the backup volume 33 will not be susceptible even if a failure occurs to the storage device 30, favorably leading to better data protection. The backup volume 33 is a storage region provided by one or more storage devices such as a disk drive, a tape drive, an MO disk drive, a CD-R disk drive, or a DVD-R disk drive.

===Flow of File Update Process===

Described next is a process to be executed by the version management system 20 responding to a request coming from the information processor 10. This process is executed to update any file currently under version control, and hereinafter referred to as file update process.

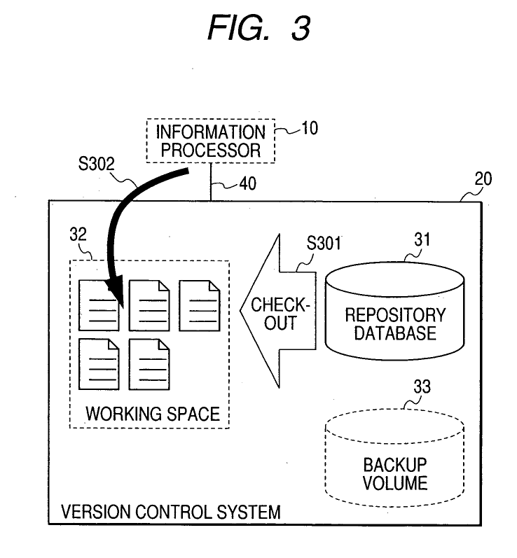

FIG. 3 is a diagram showing a check-out process to be executed based on a request coming from the information processor 10. First, the information processor 10 forwards a check-out request including version information to the version management system 20. The check-out request is received by the check-out processing section 27 in the version management system 20. The check-out processing section 27 performs file reading from the repository database 31 to the working space 32 using the version information in the received check-out request as a key (S301) This is the check-out process.

Next, the information processor 10 forwards a data writing request including a file name to the version management system 20. The data writing request is received by the data writing request receiving section 25 in the version management system 20. In the version management system 20, in accordance with the received data writing request, the data writing processing section 26 performs data writing to the file stored in the working space 32 (S302). In this manner, a change is applied to the file checked out as specified from the information processor 10.

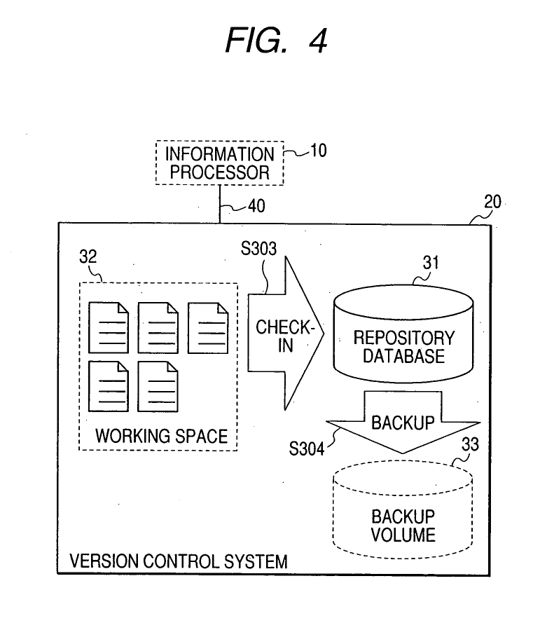

FIG. 4 is a diagram showing a check-in process. First, the information processor 10 forwards a check-in request including a file name to the version management system 20. The check-in request is received by the check-in processing section 28 in the version management system 20. Next, the check-in processing section 28 generates a unique number as the version information, and then assigns the resulting version information to the file in the working space 32 for check-in. The check-in processing section 28 adds the file to the repository database 31 together with the version information assigned thereto (S303) This is the check-in process in the version management system 20.

After the check-in processing section 28 completing check-in as such, the backup processing section 29 writes, to the backup volume 33, a copy of the file stored in the repository database 31 (S304). In this manner, the file stored in the repository database 31 is backed up.

By going through the procedure as such, the files in the repository database 31 corresponding to the respective versions are securely backed up. Herein, if necessary, the copies of the data (backup data) written into the backup volume 33 may be written into other types of media such as a tape.

The check-in may be performed not on a file basis as above, and alternatively on the basis of a group including a plurality of files, i.e., baseline defined by WebDAV specification. If this is the case, the repository database 31 stores files each including baseline identification information together with the corresponding version information. The backup processing section 29 performs file backup after every file in the same baseline is added to the repository database 31. In this manner, the files in the same baseline can be backed up with reliability.

In an alternative manner, in response to file check-out from the repository database 31, file copies may be stored in both the working space 32 and another storage region in the storage device 30. If this is the case, even while any change is applied to the file in the working space 32, the version management system 20 can read the file contents before the change from the copies. Accordingly, in a case where the information processor 10 forwards a file access request asking for data reading from the file before the change (in the below, referred to as data reading request) while making a change to the file in the working space 32, the version management system 20 can swiftly respond thereto through data reading from the file copy.

### Second Embodiment

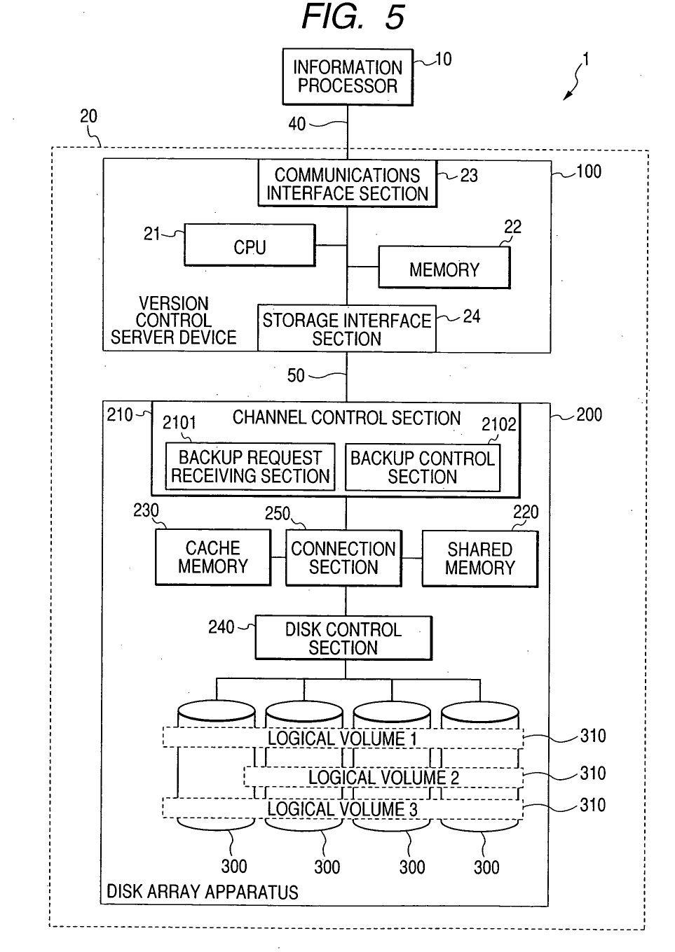

FIG. 5 is a diagram showing the information processor 1 of a second embodiment of the present invention. A version management server device 100 communicates with a disk array apparatus 200 over a SAN (Storage Area Network) 50. This communications is carried out using Fibre Channel Protocol, LAN, SCSI, iSCSI (Internet Small Computer System Interface), ESCON™ (Enterprise System Connection), FICON™ (Fibre CONnection), ACONARC™ (Advanced CONnection ARChitecture), FIBARC™ (FIBre connection ARChitecture), and others. Herein, the version management server device 100 and the disk array apparatus 200 may be directly connected to each other through an SCSI cable, for example.

The disk array apparatus 200 manages storage regions provided by a plurality of hard disk drives 300 each consists of a storage device, and exercises control over data input/output from/to the hard disk drives 300. The disk array apparatus 200 is provided with a channel control section 210, shared memory 220, cache memory 230, a disk control section 240, a connection section 250, and the hard disk drives 300. Herein, the hard disk drives 300 may be provided inside or outside of the disk array apparatus 200.

On the physical storage regions provided by the hard disk drives 300, i.e., physical volumes, one or more logically-set storage regions, logical volumes 310 are set. In this embodiment, the disk array apparatus 200 includes three logical volumes 1 to 3 (310).

The channel control section 210 includes a communications interface for communications with the version management server device 100, and from the version management server device 100, receives a data input/output request designating the address of the logical volume 310 (in the below, referred to as disk access request). After receiving such a disk access request, in accordance therewith, the channel control section 210 creates an I/O command for making an access to the logical volume 310.

The shared memory 220 and the cache memory 230 are both memory shared by the channel control section 210 and the disk control section 240. Specifically, the shared memory 220 is mainly used for storage of control information and commands, for example, the cache memory 230 is mainly used for data storage. The channel control section 210 writes thus created I/O command to the shared memory 220, and writing data and other coming together with the I/O command are written into the cache memory 230.

The disk control section 240 reads the I/O command thus written into the shared memory 220, and in accordance therewith, exercises control over data input/output from/to the logical volume 310. In the I/O command, the designated address of the logical volume 310 is converted by the disk control section 240 into a physical address of the hard disk 300 for data input/output from/to the hard disk 300. In the case where the hard disk drives 300 structuring the logical volume 310 are managed using RAID structure, the disk control section 240 makes a data access based on the RAID structure, e.g., RAID 0, 1, and 5.

The connection section 250 is a switch used for establishing a mutual connection among the channel control section 210, the shared memory 220, the cache memory 230, and the disk control section 240. The connection section 250 takes charge of data and commands coming and going among these components. In this embodiment connection section 250 is a high-speed path exemplified by a high-speed crossbar switch for data transmission through high-speed switching.

Out of the functions of the version management system 20 described in the first embodiment, the functions corresponding to the repository database 31, the working space 32, and the backup volume 33 are realized by the disk array apparatus 200, and other functions are realized by the version management server device 100. The logical volume 1 (310) in the disk array apparatus 200 includes the repository database 31. To the logical volume 2 (310) in the disk array apparatus 200, the working space 32 is provided, and to the logical volume 3 (310) therein, the backup volume 33 is provided. The backup processing section 29 performs backup by forwarding a command asking for backup (in the below, referred to as backup request) to the disk array apparatus 200.

The disk array apparatus 200 includes a backup request receiving section 2101, and a backup control section 2102. The backup request receiving section 2101 receives a backup request, and in response to the received backup request, the backup control section 2102 exercises control over the logical volume 3 (310) to store a copy of the data in the logical volume 1 (310). These backup request receiving section 2101 and backup control section 2102 can be realized in the channel control section 210 of the disk array apparatus 200.

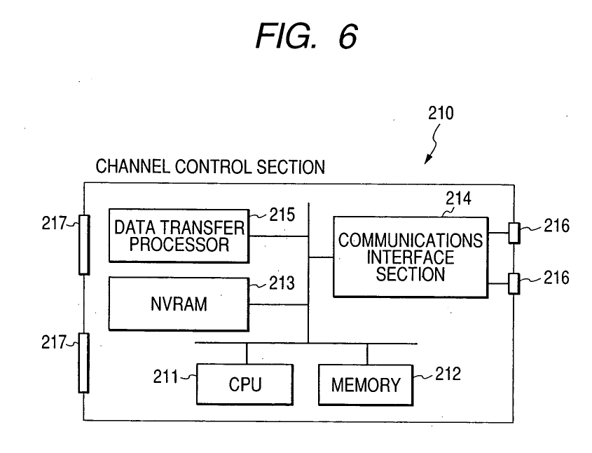

FIG. 6 is a diagram showing the structure of the channel control section 210, which includes a CPU 211, memory 212, NVRAM 213, a communications interface 214, a data transfer processor 215, and a connector 217. The CPU 211 reads an application program stored in the NVRAM 213 onto the memory 212 for execution, thereby realizing the functions such as the backup request receiving section 2101, and the backup control section 2102. The NVRAM 213 is nonvolatile memory for storing various programs and setting data. The communications interface section 214 includes a communications port 216, and thereover, carries out communications between the channel control section 210 and the information processor 10. The data transfer processor 215 is in charge of data transfer, and transfers data received by the communications interface section 214 to the memory 212, or transfers data stored in the memory 212 to the cache memory 230 of the disk array apparatus 200. The connector 217 is provided for connecting the channel control section 210 to the main body of the disk array apparatus 200. Through engagement between the connector 217 and a connector on the side of the disk array apparatus 200, the channel control section 210 is electrically connected to the disk array apparatus 200.

In such a structure, the backup control section 2102 backs up the files stored in the repository database 31, successfully reducing the processing load from the version management server device 100 at the time of file backup.

As a copy destination of the data in the logical volume 1 (310), a possible option is a backup device for data storage into a portable recording medium such as a tape drive, an MO drive, a CD-R drive, and a DVD-R drive. If this is the case, when the backup request receiving section 2101 receives a backup request from the version management server device 100, the backup control section 2102 responsively forwards the data stored in the logical volume 1 (310) to a backup device. Upon reception of the data, the backup device accordingly writes the received data to a portable recording medium. Here, the portable recording medium may be placed separately from the disk array apparatus 200 for better file protection under version control.

### Third Embodiment

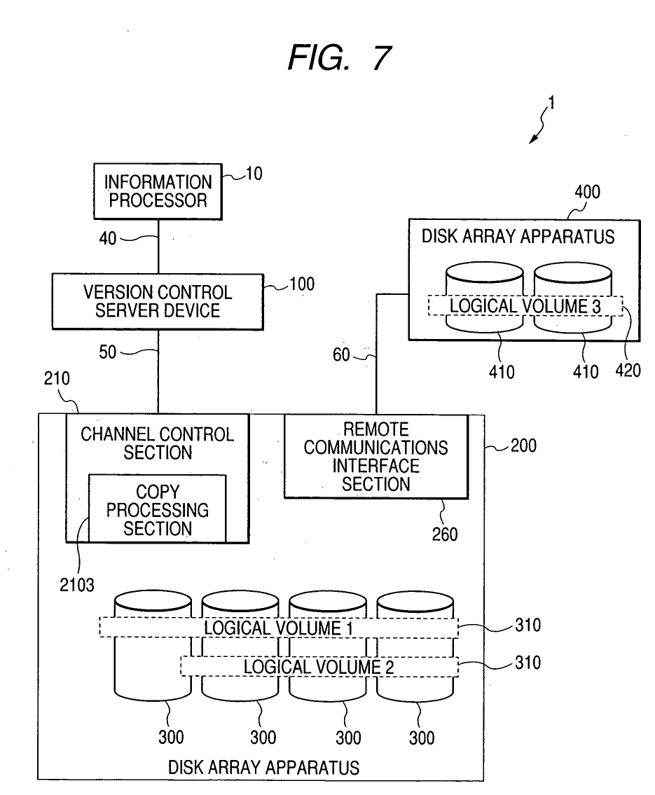

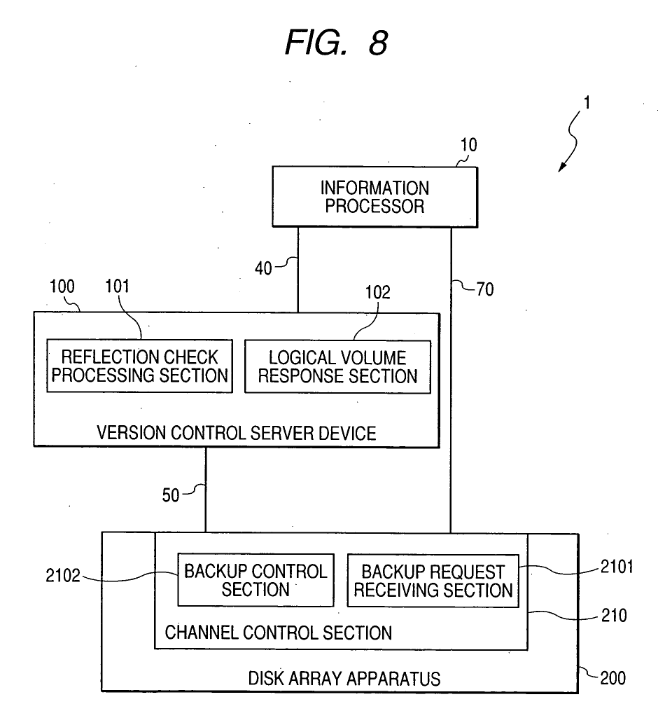

FIG. 7 is a diagram showing the structure of the information system 1 of a third embodiment of the present invention. In the present embodiment, shown is an example of remotely transferring a copy of the data stored in the logical volume 1 (310), instead of storing the copy in the disk array apparatus 200 shown in previous embodiment. In the disk array apparatus 200 of the present embodiment, the channel control section 210 of the second embodiment is additionally provided with a remote communications interface section 260 including a communications interface (channel extender) for data transfer to another disk array apparatus 400. The disk array apparatus 400 is connected to the disk array apparatus 200 through a communications path 60 for communications. The communications path 60 is exemplified by a dialup line, a dedicated line, and others. The disk array apparatus 400 is placed at a location further away from the disk array apparatus 200.

The Disk Array Apparatus 200, with remote Disk Array Apparatus 400 connected with said communication line, send a copy of data in the logical volume 310 of the first Disk Array Apparatus 200 to the logical volume 420 of the Second Disk Array Apparatus 300 through the communication line 60. Herein, those two disk array apparatuses 200 and 400 are connected together via the remote communications interface section 260 for communications. Such a process is hereinafter referred to as remote copy process, remote replication, or replication. The remote copy process is executed by a copy processing section 2103 provided in the channel control section 210. The copy processing section 2103 is realized by the CPU 211 in the channel control section 210 executing a program stored in the memory 212.

The disk array apparatus 200 is provided with the logical volume 1 (310) which stores the repository database 31, and the logical volume 2 (310) including the working space 32. The disk array apparatus 400 is provided with the logical volume 3 (420) including the backup volume 33.

After backup control section 2101 have received an incoming backup request, backup control section responsively starts remote copy process by the copy processing section 2103. In this case, the copy is from logical volume 1 (310) as copy source and logical volume 3 as a copy destination. The data written into the logical volume 1 (310) as a result of check-in performed by the check-in processing section 28 is forwarded by the copy processing section 2103 to the disk array apparatus 400 through the remote communications interface section 260. The disk array apparatus 400 then writes thus received data into the logical volume 3 (420). In this manner, a copy of data in the logical volume 1 (420) is stored in the logical volume 3 (310), and the file stored in the repository database 31 is backed up into the backup volume 33. This successfully leads to better file integrity in the repository database 31. What is better, the remote copy process is started responding to file check-in into the repository database 31, and thus the contents of the repository database 31 can be securely backed up. Here, to reduce the communication frequency with the disk array apparatus 400, making a setting not to start the remote copy process will do, i.e., to respond only to writing to the logical volume 310 as a result of the check-in process to the repository database 31. The remote communications is often high in communications cost, and rather slow in the data transfer speed. With the version management system 20 of the present embodiment, any data in the working space 32 relatively low in significance is not remotely transferred. Accordingly, this suppresses the communications amount of the communications path 60, favorably reducing the communications cost and load. Here, as an alternative setting, the remote copy process may be started responding to writing to the logical volume 310 through the process other than check-in to the repository database 31.

### Fourth Embodiment

FIG. 8 is a diagram showing the information processing system 1 of a fourth embodiment of the present invention. In the present embodiment, the information processor 10 directly instructs the disk array apparatus 200 for backup. As shown in FIG. 8, the information processor 10 is connected to the version management server device 100 over the network 40 for communications therewith, and also to the disk array apparatus 200 through a communications path 70 for communications therewith. The communications path 70 is a network exemplified by LAN, and the Internet. Herein, the communications path 70 may follow SCSI, Fibre Channel protocol, or the like.

In addition to the components as above, the version management server device 100 includes a reflection check processing section 101, and a logical volume response section 102.

The reflection check processing section 101 receives from the information processor 10 a command for inquiring whether data writing to the repository database 31 relating to check-in is completed. In the below, such a command is referred to as reflection check request. Then, the reflection check processing section 101 sends an information response indicating whether data writing to the logical volume 1 (310) is through. Assuming if the check-in processing section 28 is so set as to send a check-in-completion response to the information processor 10 prior to forwarding a check-in relating disk access request to the disk array apparatus 200, the reflection check processing section 101 sends an information response to the information processor 10 telling whether the disk access request has been forwarded to the disk array apparatus 200.

The logical volume response section 102 receives from the information processor 10 a command asking for identification information of the logical volume 310 including the repository database 31. In the below, such a command is referred to as logical volume acquisition request. Then, the logical volume response section 102 responsively sends the identification information of the logical volume 1 (310) to the information processor 10.

The reflection check processing section 101 and the logical volume response section 102 are realized by the CPU 21 in the version management server device 100 executing a program stored in the memory 22.

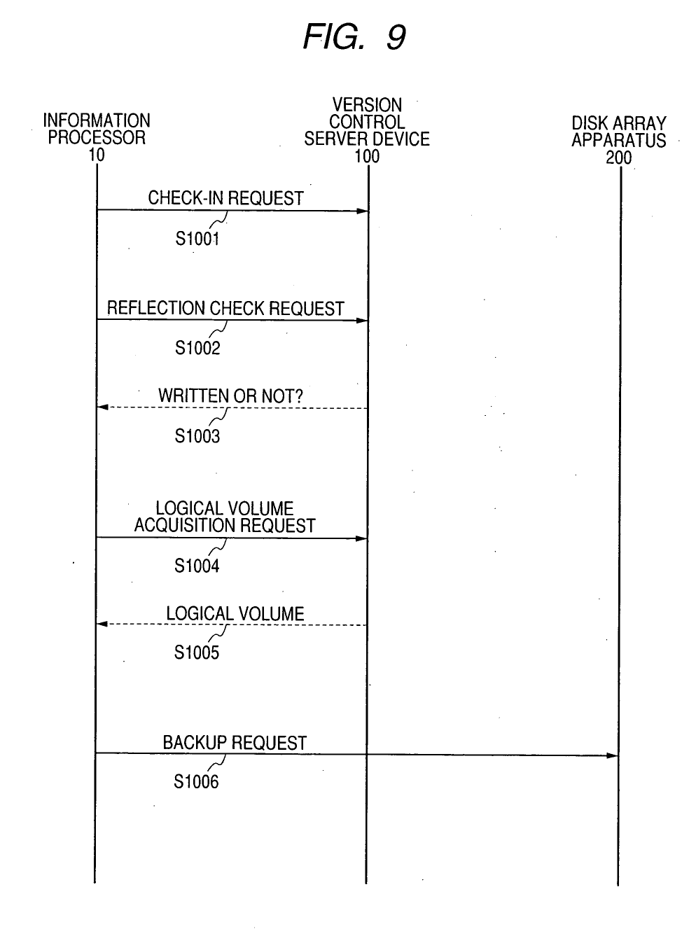

FIG. 9 is a diagram showing the process flow in the structure above, from check-in to backup.

The information processor 10 forwards a check-in request to the version management server device 100 (S1001). In response to the received check-in request, the version management server device 100 checks in a file in the working space 32 into the repository database 31. The information processor 10 then forwards a reflection check request to the version management server device 100 (S1002). The reflection check processing section 101 in the version management server device 100 sends an information response indicating whether data writing has been done to the logical volume 1 (310) (S1003). After receiving the response from the version management server device 100 for the reflection check request, and after confirming that data writing relating to check-in has been through, the information processor 10 forwards a logical volume acquisition request to the version management server device 100 (S1004). In the version management server device 100, the logical volume response section 102 sends an information response to the information processor 10 for identifying the logical volume 1 (310) (S1005).

From the response for the logical volume acquisition request, the information processor 10 acquires the logical volume 310 having stored the checked-in file data. The information processor 10 then forwards a backup request including information for identifying thus acquired logical volume 310 to the disk array apparatus 200 through the communications path 70 (S1006).

In such a manner, the backup control section 2102 of the disk array apparatus 200 refers to the received backup request to identify the logical volume 310 for backup. From thus identified logical volume 310, a copy of the data stored therein is then written to the backup volume 33. As such, the processing load can be successfully reduced from the version management server device 100 at the time of file backup.

### Fifth Embodiment

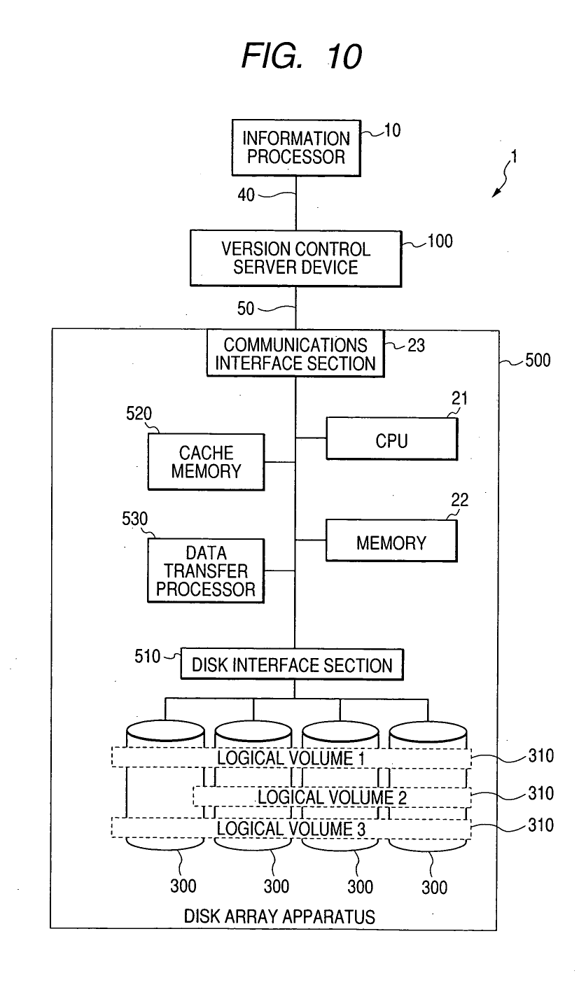

As an alternative structure, the disk array apparatus 200 of the second to fourth embodiments can be in such a structure as shown in FIG. 10.

A disk array apparatus 500 is provided with the CPU 21, the memory 22, the communications interface section 23, a disk interface section 510, cache memory 520, a data transfer processor 530, and a plurality of hard disk drives 300.

By the CPU 21 executing a program stored in the memory 22, various functions such as the backup request receiving section 2101 and the backup control section 2102 are realized. The communications interface section 23 carries out communications with the version management server device 100 over a SAN 50. The disk interface section 510 is provided for exercising control over data input/output from/to the hard disk drives 300. The cache memory 520 is a storage device for storing data coming and going between the communications interface section 23 and the disk interface section 510. The data transfer processor 530 takes charge of data transfer, i.e., transfers data received from the version management server device 100 by the communications interface section 23 to the cache memory 520, or transfers data stored in the cache memory 520 to the disk interface section 510. On the storage regions provided by the hard disk drives 300, the logical volume 310 is realized.

Note here that, in such a disk array apparatus 500, the mechanism for the backup request receiving section 2101 to receive a backup request coming from the version management server device 100, and for the backup control section 2102 to perform backup responding to the backup request is the same as the above disk array apparatus 200.

### Sixth Embodiment

In the above embodiments, the version management system 20 is implemented on the version management server device 100. This is not restrictive, and the version management system 20 may be incorporated into the disk array apparatus 200 or 500. If incorporated into the disk array apparatus 200, the various functions of the above components, i.e., the file system 24, the data writing request receiving section 25, the data writing processing section 26, the check-out processing section 27, the check-in processing section 28, and the backup processing section 29, for example, can be realized by the CPU 211 of the channel control section 210 exercising a program stored in the memory 212. As a result, the channel control section 210 operates as a NAS for receiving a file access request from the information processor 10.

In this embodiment, which the version control section 20 is incorporated into the disk array apparatus 500, the various functions of the above components, i.e., the file system 24, the data writing request receiving section 25, the data writing processing section 26, the check-out processing section 27, the check-in processing section 28, and the backup processing section 29, for example, can be realized by the CPU 21 of the disk array apparatus 500 exercising a program stored in the memory 22. The disk array apparatus 500 is connected to the information processor 10 for communications over the network 40, and receives a file access request from the information processor 10. With such a structure, the disk array apparatus 500 operates as NAS.

Although the first to sixth embodiments are described in detail, the foregoing description is in all aspects for facilitating but not restricting the understanding of the present invention. It is understood that numerous other modifications and variations can be devised without departing from the scope of the present invention, and the present invention is directed also to the resulting equivalents.

As an exemplary structure, a version control command receiving section may be provided for receiving version control commands other than check-out requests and check-in requests. If this is the case, it is so set as to perform backup when a command is received for updating the repository database 31. For example, backup may be performed responding to a VERSION-CONTROL command for adding any new file to the repository database 31. As a result, file backup can be done with more reliability for the files stored in the repository database 31.

Alternatively, the check-in processing section 28 may determine whether the repository database 31 has been updated with a reference to the checked-in file. Specifically, assuming if a check-in request comes from the information processor 10 with no change made to the checked-out file, the check-in processing section 28 may have an option not to update the repository database 31. This can suppress the processing load and the communications load, which are often caused to be large due to backup of not-yet-updated files.

In the above first to sixth embodiments, in the version management system 20, any file checked out from the repository database 31 goes to the working space 32 for storage therein, i.e., in a form of server side working space implementation. This is not surely restrictive, and a form of client side working space will do, specifically, downloading any file checked out from the repository database 31 by the information processor 10. If this is the case, the information processor 10 stores the resulting downloaded file into a storage device exemplified by memory, makes a change to the stored file, and uploads the file after the change to the version management system. The file uploaded from the information processor 10 is stored in the working space 32, and checked in to the repository database 31 responding to a check-in request coming from the information processor 10. Herein, as an alternative manner, the information processor 10 may forward a check-in request to the version management system 20 together with the file after change.

The working space 32 may serve as a storage region to be dynamically reserved on the storage device 30. If this is the case, for example, the version management server device 100 in the above forwards to the disk array apparatus 200 a command asking for creating a copy of the data stored in the logical volume 1 (310). The disk array apparatus 200 accordingly reserves a storage region as a copy destination, and sends an information response to the version management server device 100 for identifying thus reserved storage region.

Further, in the above first to sixth embodiments, the file system provided by the version management system 20 receives a file access request following the WebDAV protocol. This is not restrictive, and other than the WebDAV protocol, a file access request may follow an NFS (Network File System) protocol, a CIFS (Common Internet File System) protocol, and others. Moreover, receiving a command defined by software such as CVS (Concurrent Versions System), Visual SourceSafe™, ClearCase™, and the like, corresponding to check-in and check-out requests. As an example, the present invention is applicable to a case where version control is applied by the CVS on a file system by the NFS.

1. A version management system comprising:
a CPU;
a communications interface section coupled to communicate with an information processor;
a repository database configured to store a file, including version information;
a check-out processing section configured to receive a check-out request from the information processor to check-out the file from the repository database;
a data writing request section configured to receive from the information processor a data writing request which includes information for identifying the file;
a file writing section configured to write data to the checked out file in response to the data writing request;
a check-in processing section configured to receive a check-in request from the information processor to check-in the checked out file; and
a backup processing section configured to perform backup of the file stored in the repository database in response to completion of the check-in by the check-in processing section, wherein
the check-out processing section, the data writing request receiving section, the file writing processing section, the check-in processing section, and the backup processing section are implemented by the CPU executing a stored program.

2. The version management system according to claim 1 wherein the data writing request is provided from the information processor in accordance with a WebDAV protocol.

3. The version management system according to claim 1 further comprising:
first and second logical volumes each serving as a storage region logically defined on a storage region provided by a storage device; wherein
the repository database is stored in the first logical volume; and
the backup processing section performs the backup by writing, into the second logical volume, a copy of data stored in the first logical volume.

4. The version management system according to claim 1 further comprising
first and second storage devices, wherein:
the repository database is stored in a storage region provided by the first storage device, and
the backup is performed by writing into a storage region provided by the second storage device, a copy of data stored in the storage region provided by the first storage device.

5. The version management system according to claim 1 wherein:
the repository database stores the file together with identification information for identifying a group of files;
in response to the check-out request, the check-out processing section checks out from the repository database the file having the same identification information; and
the backup is performed after the file is checked in.

6. A version management server device comprising:
a CPU;
a communications interface connected to communicate with an information processor;
a storage interface connected to communicate with a storage device control unit including a repository database configured to store a file including version information;
a check-out processor configured to receive a check-out request from the information processor for checking out the file from the repository database;
a data writing request receiver configured to receive from the information processor a data writing request including file identification information;
a file writing processor configured to write data to the file read out from the repository database in response to the data writing request;
a check-in processor configured to receive a check-in request from the information processor for checking in the checked out file to the repository database, and in response to the received check-in request, for checking in the checked out file to the repository database; and
a backup processor configured to perform backup of the file stored in the repository database in response to completion of the check-in by the check-in processor, wherein
the check-out processor, the data writing requestor, the file writing processor, the check-in processor, and the backup processor are realized by the CPU executing a stored program.

7. A storage device control unit comprising:
a CPU;
a communications interface connected to an information processor;
a disk interface configured to exercise control over data operations with a storage device;
a cache memory configured to store data passing between the communications interface and the disk interface;
a repository database configured to store a file, including version information;
a check-out processor configured to receive a check-out request from the information processor to read out the file from the repository database;
a data writing request receiver configured to receive from the information processor a data writing request including file identification information;
a file writing processor configured to perform data writing to the checked out file in response to the data writing request;
a check-in processor configured to receive a check-in request from the information processor to cause check-in of the checked out file to the repository database; and
a backup processor configured to perform backup of the file stored in the repository database in response to completion of the check-in by the check-in processor, wherein
the check-out processor, the data writing request receiver, the file writing processor, the check-in processor and the backup processor are implemented by the CPU executing a stored program.

8. The version management server device according to claim 6 wherein the data writing request is provided from the information processor in accordance with a WebDAV protocol.

9. The version management server device according to claim 6 further comprising:
first and second logical volumes each serving as a storage region logically defined on a storage region provided by a storage device; wherein
the repository database is stored in the first logical volume; and
the backup processing section performs the backup by writing, into the second logical volume, a copy of data stored in the first logical volume.

10. The version management server device according to claim 6 further comprising
first and second storage devices, wherein:
the repository database is stored in a storage region provided by the first storage device, and
the backup is performed by writing into a storage region provided by the second storage device, a copy of data stored in the storage region provided by the first storage device.

11. The version management server device according to claim 6 wherein:
the repository database stores the file together with identification information for identifying a group of files;
in response to the check-out request, the check-out processing section checks out from the repository database the file having the same identification information; and
the backup is performed after the file is checked in.

12. The storage device control unit according to claim 7 wherein the data writing request is provided from the information processor in accordance with a WebDAV protocol.

13. The storage device control unit according to claim 7 further comprising:
first and second logical volumes each serving as a storage region logically defined on a storage region provided by a storage device; wherein
the repository database is stored in the first logical volume; and
the backup processing section performs the backup by writing, into the second logical volume, a copy of data stored in the first logical volume.

14. The storage device control unit according to claim 7 further comprising
first and second storage devices, wherein:
the repository database is stored in a storage region provided by the first storage device, and
the backup is performed by writing into a storage region provided by the second storage device, a copy of data stored in the storage region provided by the first storage device.

15. The storage device control unit according to claim 7 wherein:
the repository database stores the file together with identification information for identifying a group of files;
in response to the check-out request, the check-out processing section checks out from the repository database the file having the same identification information; and
the backup is performed after the file is checked in.
